(19) United States
(12) Patent Application Publication
(10) Pub. No.: US 2004/0230437 A1
(43) Pub. Date: Nov. 18, 2004

(54) Method for assessing and managing security risk for systems

(76) Inventor: Robert J. Havrilak JR., Minnetonka, MN (US)

Correspondence Address: ALTERA LAW GROUP, LLC, 6500 CITY WEST PARKWAY, SUITE 100, MINNEAPOLIS, MN, 55344-7704, US

(21) Appl. No.: 10/426,469

(22) Filed: Apr. 29, 2003

(51) Int. Cl. G06F 17/60

(52) U.S. Cl. 705/1

(57) ABSTRACT

A method for assessing and managing security risks in an iterative fashion. The method is adaptable for use in virtually any system that has embedded targets that are accessible to a security threat. A particular adaptation includes use of the method to secure risks in the food manufacturing, production, processing and distribution industries. Using the inventive process, a risk to the system exists if a threat has access to a security target. The method provides an iterative process by which the system is initially divided into discrete and manageable sections and all known security targets are identified within each section. Then, on a section-by-section basis all known threats to each individual target are identified and it is determined whether the individual threat has access to the associated target. If access is present, a risk level is assigned and, ultimately, mitigated. When all sections are secure, the entire system is deemed secure.

### FIELD OF THE INVENTION

This invention relates generally to security risk assessment and security risk management.

### BACKGROUND OF THE PRESENT INVENTION

Risk analysis and risk management is well understood, is applied in a variety of fields and consist of a systematic application of policies, procedures and practices to the analysis, evaluation and control of risks. The risk analysis and management process generally involves the identification of particular hazards to a system, including raw materials, processes, work-in-process, finished goods and distribution. Known risk management processes generally suggest that a risk estimate be determined for individual hazards. The typical risk estimate is a function of the relative likelihood of its occurrence, the severity of harm resulting from the hazard's consequences and the exposure of people, equipment and inventory to the hazard. Once the risk estimate is established for a particular hazard, risk management focuses on controlling or mitigating the risks.

The literature is replete with references to various forms of industry-specific risk assessment and risk management tools. However, these references are very often targeted to particular industries or tasks and, as a result, are particularly unsuitable for broad applicability. The present invention is quite suitable for broad application. These same references fail to disclose an iterative process after identification of hazards and implementation of control measures that allows a more manageable and effective way to ensure the overall security of a complex system by partitioning the system into a series of discrete and easily manageable sections wherein the sections are secured individually as a means to ensuring the overall security of the system.

The references also fail to disclose the process of reassessing the effect of the control measure on the risk level, determining whether such risk level is acceptable and, if unacceptable, implementing further control measures and reassessing the resulting risk until such risk becomes acceptable or is eliminated altogether on a section-by-section, threat-by-threat basis. The references also fail to focus on restricting or eliminating access of the identified hazard or threat to the associated target as the primary method of risk reduction or elimination.

Finally, other known security risk assessment and management tools known in the art provide what are essentially risk triangles, with each leg of the triangle representing a required component in order for a risk to be present. In such graphic representations of risk analysis and management, each element represented by a leg of the triangle must be present in order for a risk to be present. Elimination of one element is sufficient to remove the risk. No known risk triangle, however, is comprised of Threat, Access and Target as contemplated by the present invention. A primary focus of the present invention is, in part, removal of the access of the threat to the target in order to mitigate the associated risk.

The restriction of access of threats to identified targets in the systems embodied, e.g., in the food and beverage manufacturing, processing and distribution industries, including facilities, processes, products, vendors and distribution networks is a primary focus of the present invention and is most efficient and effective way to manage risk within those industries.

The present invention accomplishes these goals.

### SUMMARY OF THE INVENTION

A method for assessing and managing security risks in an iterative fashion. The method is adaptable for use in virtually any system that has embedded targets that are accessible to a security threat. A particular adaptation includes use of the method to secure risks in the food manufacturing, production, processing and distribution industries.

Using the inventive process, if a security threat can access a target within a system then a risk to the system is present. The method provides an iterative process by which the system is initially divided into discrete and manageable sections and all known security targets are identified within each section. Then, on a section-by-section basis all known threats to each individual target are identified and it is determined whether the individual threat has access to the associated target. If access is present, a risk level is assigned. The risk level may be qualitative or quantitative depending on the particular needs of the system. Following risk identification and risk level determination, appropriate countermeasures are considered and, where appropriate, implemented if the risk level is unacceptably high. Then a second inquiry is made regarding whether the particular threat has access to its identified target, considering the implemented countermeasure(s), and a second risk level assignment performed. If the risk level is still unacceptably high, the process is repeated until the risk level for the subject target is acceptably low or eliminated altogether. The remaining targets within a given section are secured in this manner until the section itself is secured. The remaining sections are then successively and systematically secured under the inventive process. When all sections are secure, the entire system is deemed secure.

An object and advantage of the invention is to provide a systemic security risk mitigation method for use in any industrial production and/or distribution system that is susceptible to external or internal risks that can be mitigated.

Another object and advantage of the invention is to provide a security risk mitigation method intended for use in the food processing, manufacturing and distribution industry.

Yet another object and advantage of the invention is to provide a security risk mitigation method intended for use in the beverage production and distribution industry.

Another object and advantage of the invention is to provide a security risk mitigation method that is applied to very discrete and manageable components of the system so that when the risks have been mitigated across all components, the system risk is acceptable.

The foregoing objects and advantages of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWINGS

FIG. 1 is a flowchart of the security risk assessment and management method.

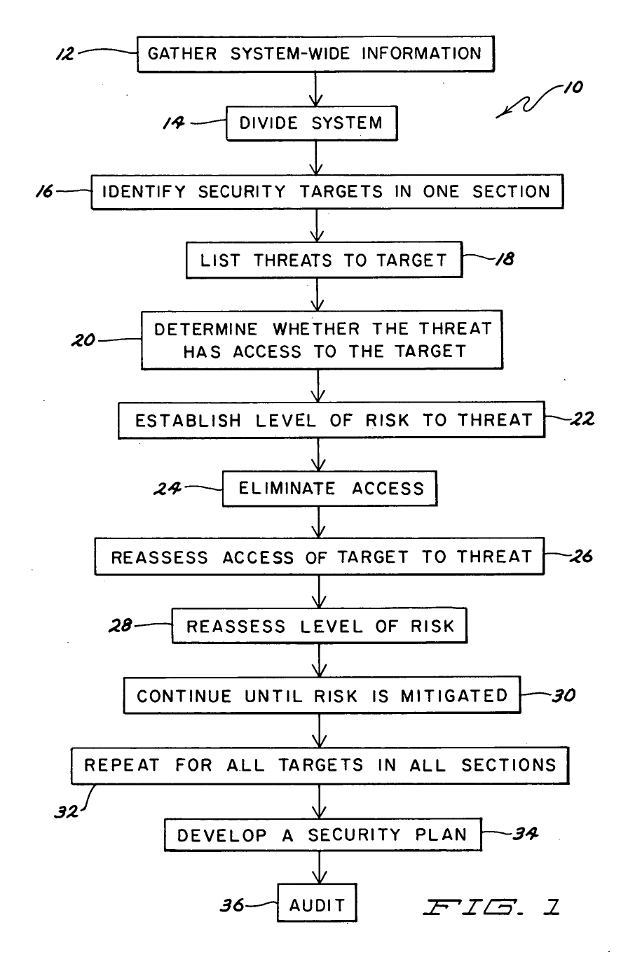

### DETAILED DESCRIPTION OF THE INVENTION

With reference to the accompanying figure, there is provided a method (10) for assessing and managing security risks to systems generally and in the food and beverage manufacturing, processing and distribution and water distribution industries specifically. It is understood that the iterative techniques disclosed in the method have broad applicability to systems that have targets embedded within the system that are vulnerable to attack from existing or potential threats.

The security risk assessment and security management method disclosed herein applies to systems. The systems are defined as including all aspects of an operation. For example, as applied to the food and beverage manufacturing, production and distribution industries, such systems may include facilities, personnel, operational processes, raw materials, work-in-process, finished goods, vendor operations, distribution networks and all personnel working within the system. Such systems may be include operating procedures relating to operations such as receiving, storage, reuse, packaging and distribution of raw materials, work-in-process and finished product.

Security risks are comprised of three basic elements: a target, a threat to the target, and access for the threat to the target. An example of a target in the food industry is raw material storage. Raw material may be tampered with or contaminated during storage and, as a result, is a security target as contemplated by the present invention. An example of a threat to the target in this situation include employees or any other person having the ability to enter the raw material storage area. The final element required to present a security risk is access of the threat to the target. Thus, any employee having the ability to enter the area where the target raw material is stored is considered to have access and, under the inventive method, to be a security risk as a result. A primary focus of the inventive process is to eliminate the security risk by systematically eliminating or restricting all access of threats to the associated targets.

The inventive method (10) begins with the gathering and analysis of all relevant system-wide information (12). Such information may include site plans, personnel information, past criminal history near the system, past security incident reports, any past recall incidents, existing countermeasures for threats or hazards to the system and the like.

Once the system-wide information is assembled and analyzed, the system is then divided into very discrete and manageable components or sections (14). A system section is defined as a subpart of the overall system. Individual circumstances and the complexity of the system will dictate the scope of the section ultimately selected for analysis and security risk mitigation. By way of example, in the food manufacturing, production, processing and distribution industry, a section may be defined as the raw material incoming receiving process. Alternatively, if the raw material incoming receiving process is too complicated to be considered as a whole, it may be further divided into a raw material receiving section, a raw material inspection section, and a raw material testing section.

The system components are discretely sectioned according to the invention so that overall system risk managed and accomplished more easily. Without such discrete sectioning, the risk assessment would be too cumbersome for most complex systems and likely contain unidentified or latent threats that remain unmitigated, resulting in unnecessary risk to the system. The discrete sectioning and systematic focus on targets and threats embedded therein greatly reduces the likelihood of latent or unidentified risks to the overall system. The mitigation of the overall system risk is accomplished according to the invention by identifying and either eliminating or mitigating the security risks in an individual section to an acceptable level. Once each individual section is secured, the overall system is deemed secure.

When the individual discrete sectioning is complete, the security risk assessment focuses on one section at a time according to the invention. Thus, all existing or potential known security targets within an individual section of the system are identified and documented (16). Next, all existing or potential known threats to a particular target are identified and documented (18). A determination is then made regarding whether each identified threat has access to the associated target (20), considering all relevant existing countermeasures that were identified during the system-wide information gathering stage (12).

Once the determination as to whether the threat has access to the target has been made, a value may be assigned to the associated level of risk (22). Obviously, if a threat cannot access a target, there is no, or negligible, risk. However, when a threat can access a target, a risk is present. The level of risk may be qualitative, e.g., high, medium, low, or qualitative depending on the particular importance of the system, or section thereof. Individual sections may be treated differently in terms of level of risk assessment in that system sections of high or critical importance may be assessed quantitatively while other non-critical sections may be assessed qualitatively.

If the individual level of risk for a given target is determined to be unacceptably high, countermeasures may be implemented to mitigate the risk by either restricting or eliminating the access of the threat to the target (24). Once the countermeasures are implemented, a follow-up determination is made to determine whether the target is still accessible to the threat (26) and the resulting level of risk reassessed (28). If the level of risk still remains unacceptably high, additional countermeasures are implemented to eliminate or restrict the access of the threat to the target in an iterative fashion until the risk level becomes acceptably low (30).

Each individual target with a discrete system section is evaluated in the manner described above until all the risks associated with all threatened targets within an individual section have been reduced to an acceptable level or eliminated altogether and the individual section has been secured. The process then proceeds to the next system section and is repeated until all threatened targets in all sections have been secured (32). At this point, the entire system is secure. A security plan may be developed to document each identified target, the mode of access to the target by the threat, the levels of risk for each threatened target, the associated countermeasures implemented to eliminate or restrict access of the threat to the target thus mitigating the risk, and the final risk level for each target (34). The security plan may be audited on a periodic basis to ensure compliance with the implemented countermeasures and to ensure the security of the individual system sections as well as the system as a whole (36).

In an alternate embodiment, a section threat level may be established after the gathering and analysis of system-wide information and the division of the system into discrete sections is complete. A section threat level is either a qualitative or quantitative assignment of threat level risk to one or more sections in the system. In certain instances, it is understood that some systems may have individual sections that are of more critical importance than others and, as a result, may require different risk assessment and management approaches than other less critically important sections. For example, an organization may consider a system section dealing with work-in-process to be more critical or more vulnerable to security risks than a distribution section. Thus, the work-in-process section may be assigned a quantitative section threat level of high while the distribution section is assigned a section threat level of low. A section threat level of high will receive a greater level of scrutiny in the security risk assessment and management inquiry than will a section threat level of low. In the example, the work-in-process section will receive a much higher degree of scrutiny under the inventive method in terms of identifying targets, threats to the targets and access of the threat to the target than will the distribution section. A number of factors influence the decision regarding whether a section threat level should be established for an individual section(s) within the system, e.g., history of past security incidents in connection with the section, number and education level of personnel coming into contact with the section activities, etc.

Alternatively, a location threat level can be established by assigning a threat risk level to one or more individual locations within the system. A location threat level is either a qualitative or quantitative assignment of threat level risk for one or more locations within the system. For example, an organization may consider a location where the food formulation and preparation occurs to be more critical or more vulnerable to security risks than a finished product distribution center location. Again, this determination is based upon a variety of factors. Thus, the formulation and preparation location may be assigned a quantitative location threat level of high or medium and the finished goods distribution center location a location threat level of low. A location threat level of high will receive a greater level of scrutiny in the security risk assessment and management inquiry than will a location threat level of low. Thus, in the example, the formulation and preparation location will be reviewed much more closely for targets, threats to the targets and access of the threat to the target than will the distribution center location.

The location threat level may be established following the assembly and analysis of system-wide information and the division of the system into discrete and manageable sections. Whether such an approach is preferred is entirely subjective and is dependent upon a number of factors including, e.g., needs of the system administrators, criminal activity near the particular location, history of past security incidents in the area, the physical layout and complexity of the facility in the location to name a few. As with the section risk level, location risk levels can be assigned qualitative or quantitative values. Additionally, as with the section risk level, only a subset of all locations may be required to have a location risk threat level assigned.

The above specification describes certain preferred embodiments of this invention. This specification is in no way intended to limit the scope of the claims. Other modifications, alterations, or substitutions may now suggest themselves to those skilled in the art, all of which are within the spirit and scope of the present invention. It is therefore intended that the present invention be limited only by the scope of the attached claims below:

1. A method for assessing and managing security risks to systems, the systems including facilities, personnel, processes, vendors and products, the method comprising:
gathering background information, facility information, operational procedures, product information and existing security risk countermeasures;
dividing the system into manageable sections;
identifying known security targets in one section of the system;
listing known threats for each identified target in the section;
determining whether each threat has access to the associated target in the section, considering existing countermeasures;
assigning a qualitative value to the level of risk when a threat is determined to have access to a target;
securing the section by successively restricting or eliminating access of each threat to the associated target until the risk for each target is acceptably low;
securing all sections within the system by successively restricting or eliminating access of each threat within each section to the associated target until all associated risks are evaluated and mitigated to acceptable levels;
developing a security plan to document the targets, access of the threats to the targets, the associated levels of risk and associated countermeasures to mitigate the risks; and
auditing to the security plan on a periodic basis.

2. The method of claim 1 further comprising establishing a quantitative risk level for each target with an accessible threat.

3. The method of claim 1, wherein the countermeasures are physical and procedural.

4. The method of claim 1, further comprising establishing a section threat level for at least one section.

5. The method of claim 1, further comprising dividing the system into manageable sections and locations; and establishing a location threat level for at least one location.

6. The method of claim 1 further comprising assessment and management of security risks to facilities and processes involved in receiving, storage, packaging and reuse of raw materials, work-in-process and finished product.

7. The method of claim 1, further comprising assessing and managing security risks to food and beverage manufacturing, production and distribution systems.

8. A method for assessing and managing security risks to food and beverage production and distribution systems, the systems including facilities, personnel, processes, and products, the method comprising:
gathering background information, facility information, operational procedures, product information and existing security risk countermeasures;
dividing the system into manageable sections;
establishing section threat level for at least one section in the system;
identifying known security targets in one section of the system, including those related to raw materials, work-in-process and finished product;
listing known threats for each identified target in the section;
determining whether each threat has access to the associated target in the section, considering existing countermeasures;
assigning a qualitative value to the level of risk when a threat is determined to have access to a target;
securing the section by successively restricting or eliminating access of each threat to the associated target until the risk for each target is acceptably low;
securing all sections within the system by successively restricting or eliminating access of each threat within each section to the associated target until all associated risks are evaluated and mitigated to acceptable levels;
developing a security plan to document the targets, access to the targets, risk involved and associated countermeasures; and
auditing to the security plan on a periodic basis.

9. A method for assessing and managing security risks to food and beverage production and distribution systems, the systems including facilities, personnel, processes, and products, the method comprising:
gathering background information, facility information, operational procedures, product information and existing security risk countermeasures;
dividing the system into manageable sections and locations;
establishing a location threat level for at least one location in the system;
identifying known security targets in one section of the system, including those related to raw materials, work-in-process and finished product;
listing known threats for each identified target in the section;
determining whether each threat has access to the associated target in the section, considering existing countermeasures;
assigning a qualitative value to the level of risk when a threat is determined to have access to a target;
securing the section by successively restricting or eliminating access of each threat to the associated target until the risk for each target is acceptably low;
securing all sections within the system by successively restricting or eliminating access of each threat within each section to the associated target until all associated risks are evaluated and mitigated to acceptable levels;
developing a security plan to document the targets, access to the targets, risk involved and associated countermeasures; and
auditing to the security plan on a periodic basis.
